(19) United States
(12) Patent Application Publication
(10) Pub. No.: US 2003/0150082 A1
(43) Pub. Date: Aug. 14, 2003

(54) Suitcase handle structure

(76) Inventor: Wei-Chih Chen, Taichung City (TW)

Correspondence Address: Charles E. Baxley, Hart, Baxley, Daniels & Holton, Fifth Floor, 59 John Street, New York, NY, 10038, US

(21) Appl. No.: 10/073,188

(22) Filed: Feb. 12, 2002

(51) Int. Cl. E05B 7/00

(52) U.S. Cl. 16/114.1

(57) ABSTRACT

A handle assembly for a suitcase includes a fabric stripe with two ends fixed on the suitcase and a receiving space is defined in the fabric stripe. A hollow and flexible bar is received in the receiving space. A handle has a passage defined therethrough and the bar and the fabric stripe receiving the bar are received in the passage. The bar has protrusions which are engaged with an inside of the fabric stripe. The bar is deformed according to the load of the suitcase.

### FIELD OF THE INVENTION

The present invention relates to a handle assembly for a suitcase wherein the handle includes a hollow shaft which is deformed according to the load of the suitcase.

### BACKGROUND OF THE INVENTION

A conventional suitcase handle assembly is shown in FIG. 1 and generally includes a fabric stripe 11 and two ends of the fabric stripe 11 is fixedly connected to the suitcase 16 by fixing members 15. A solid bar 12 is received in a receiving space 101 in the fabric stripe 11 and the two items are extended through a handle 10. Although the handle 10 has soft fins on an outer periphery thereof to provide comfortable grab for the users, the solid bar 12 cannot be deformed when the load of the suitcase 16 is heavy. This makes the load to be concentrate at the intermediate portion of the bar 12 and the user's hand. Besides, when the user pulls the handle 10 at an angle, because the solid bar 12 is smooth so that the position that the bar 12 in the fabric stripe 11 could shift.

### SUMMARY OF THE INVENTION

In accordance with one aspect of the present invention, there is provided a handle assembly for a suitcase and the assembly comprises a fabric stripe having a receiving space defined therein so as to receive a hollow and flexible bar therein. Two ends of the fabric stripe are fixed to the suitcase. A handle has a passage defined therethrough and the fabric stripe extends through the passage and the bar is located in the passage.

The primary object of the present invention is to provide a handle assembly for a suitcase wherein the handle is deformed according the load of the suitcase.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show a conventional handle assembly of a suitcase;

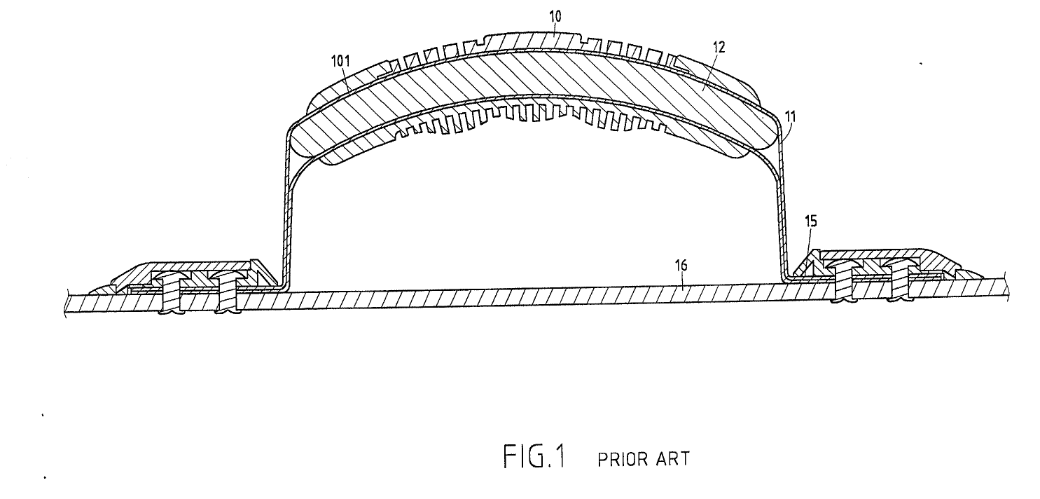

FIG. 2 is an exploded view to show a handle assembly of the present invention;

FIG. 3 is a cross sectional view to show the handle assembly of the present invention, and

FIG. 4 is a cross sectional view to show the handle assembly of the present invention wherein the handle is deformed when the load of the suitcase increases.

### DETAILED DESCRIPTION OF THE PREFERRED EMBODIMENT

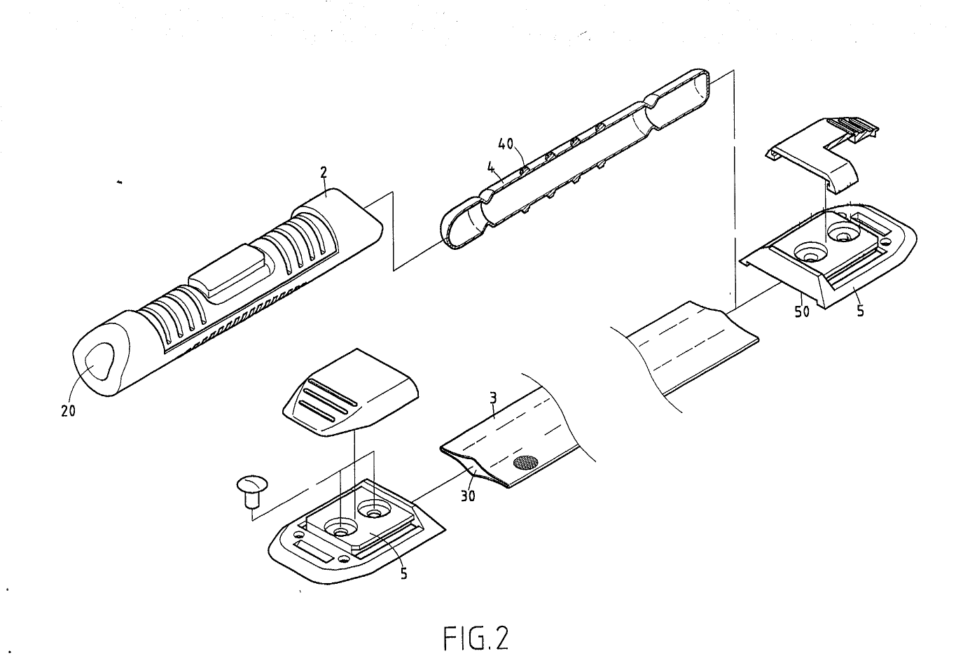

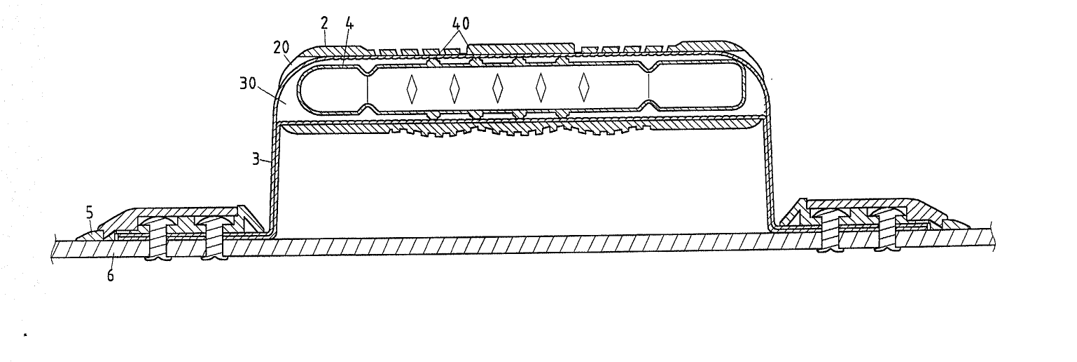

Referring to FIGS. 2 and 3, the handle assembly for suitcases of the present invention comprises a fabric stripe 3 that has an elongated receiving space 30 defined therein, and two ends of the fabric stripe 3 are fixed to the suitcase 6 by two fixing members 5. A hollow and flexible bar 4 is received in the receiving space 30 and a plurality of protrusions 40 extend radially outward from an outside of the bar 4.

A handle 2 has a passage 20 defined therethrough and the fabric stripe 3 extends through the passage 20 and the bar 4 is located in the passage 20. The outer diameter of the protrusions 40 is properly sized so that the protrusions 40 just fit and contact an inside of the receiving space 30.

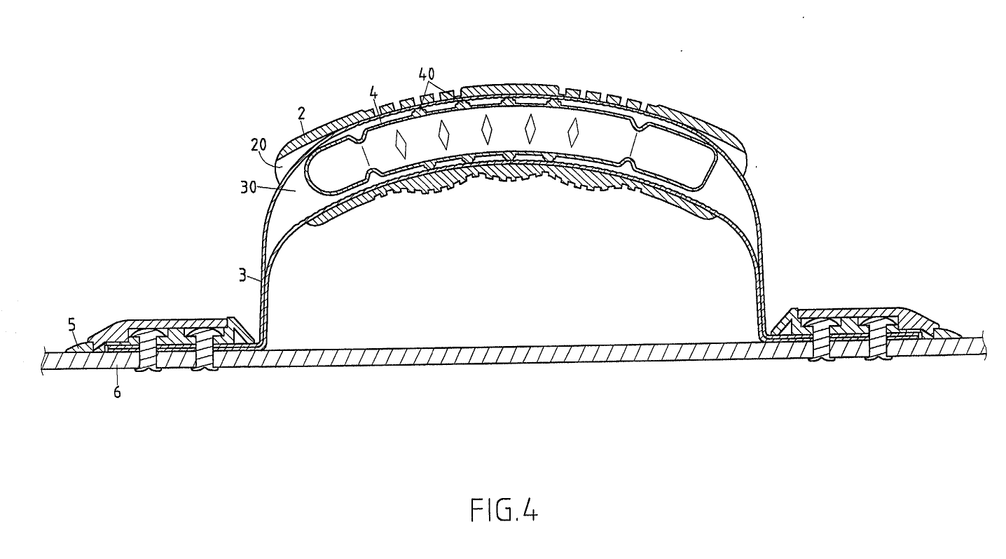

As shown in FIG. 4, when the load of the suitcase 6 is heavy, when the user's hand holds the handle 2, the flexible bar 4 is properly deformed and the user's hand has enough contact area with the handle to avoid the load from centering at a limited contact area.

While we have shown and described the embodiment in accordance with the present invention, it should be clear to those skilled in the art that further embodiments may be made without departing from the scope of the present invention

What is claimed is:

1. A handle assembly for a suitcase, comprising:
a fabric stripe that has a receiving space defined therein, two ends of said fabric stripe adapted to be fixed to the suitcase;
a hollow and flexible bar received in said receiving space, and
a handle having a passage defined therethrough and said fabric stripe extending through said passage and said bar located in said passage.

2. The handle assembly as claimed in claim 1 further comprising protrusions extending radially outward from an outside of said bar and said protrusions contacting an inside of said receiving space.
